(19) United States
(12) Patent Application Publication
(10) Pub. No.: US 2004/0083798 A1
(43) Pub. Date: May 6, 2004

(54) Detection of filter breakthrough

(76) Inventor: Michael J. Sadar, Ft. Collins, CO (US)

Correspondence Address: Dean P. Edmundson, P.O. Box 179, Burton, TX, 77835, US

(21) Appl. No.: 10/694,152

(22) Filed: Oct. 27, 2003

Related U.S. Application Data
(60) Provisional application No. 60/423,782, filed on Nov. 5, 2002.

(51) Int. Cl. G01N 11/00

(52) U.S. Cl. 73/53.01

(57) ABSTRACT

A monitoring system for monitoring a parameter of a fluid stream. The system includes a sample cell with inlet and outlet ports for fluid, a light source, detector, fiber optic cables for transmitting light to the sample cell and transmitting a signal back to the detector. The baseline variability of parameter measurements are calculated.

### CROSS-REFERENCE TO RELATED APPLICATION

This application is based upon, and claims priority from, my Provisional Application No. 60/423,782, filed Nov. 5, 2002.

### FIELD OF THE INVENTION

This invention relates to detection of particles in fluids. More particularly, this invention relates to detection of particles through the use of light-scattering instrumentation, e.g. turbidimeters. Even more particularly, this invention relates to the analysis and processing of the variability of the turbidity signal. In another aspect, this invention pertains to relating the variability of the turbidity signal to the detection and qualification of a filter breakthrough event.

### BACKGROUND OF THE INVENTION

Turbidity is a basic monitor of water quality, and has been used in the monitoring of drinking water, including that which is produced by filtration. Turbidity measurement involves the use of a light beam, with defined characteristics, to determine the quantity of particulate material present in the water or other fluid sample. The light beam is referred to as the incident light beam. The particulate material in the water will cause the incident light beam to be scattered and this scattered light is detected and quantified relative to a traceable calibration standard material. The greater the quantity of the particulate material that is contained in a sample, the greater the scattering of the incident light beam and the higher the resulting turbidity.

Turbidimeters and the data they produce (i.e. turbidity values) represent the entire quantity of material present in a sample. The measured value is compared to a primary analytical standard that is used to calibrate the turbidimeter. The higher the turbidity value, the higher the particulate concentration for a given sample or stream. This turbidity value can be reported in a number of different turbidity units of measurement, which are often selected based on the type of light source and detection angle used to make the turbidity measurement.

Turbidity is typically reported in one of several types of turbidity units. The units are varied and can be: Turbidity Unit (TU), Nephelometric Turbidity Unit (NTU), Formazin Nephelometric Unit (FNU), Formazin Attenuation Unit (FAU), Backscatter Turbidity Unit (BTU), and other units. The units are intended to provide a specific means of traceability to the type of measurement that is made from a design standpoint, and the type of standard that is used to calibrate the respective instrumentation. For example, the nephelometric turbidity unit (NTU) indicates that the scattered light detector is located at a 90-degree angle relative to the centerline of the incident light beam. A backscatter turbidity unit indicates that the measurement was performed using a scattered light detector that is at a typical backscatter angle relative to the centerline of the incident light beam. Last, the FNU indicates the use of the regulatory method from the International Standardization Organization (ISO) Method 7027, which mandates specific design and calibration standard criteria.

Turbidimeters do not measure qualitative aspects regarding a given sample such as: specific particle size, range of particle sizes, shape, or color, i.e. morphology of the particles in a sample. A turbidity measurement simply represents the combined light scatter of all particles that are present in an incident light beam for any given interval of time.

In referencing instrumentation, particle counting often refers to instrumentation that detects particles using light obscuration techniques. The lower size limit for this technology has been determined to be around 1 micron in particle diameter and most instruments specify a size limit of 2 microns. Turbidimeters are those instruments that apply traditional incandescent white light or light emitting diodes as the incident light sources and are said to comply with traditionally accepted regulatory design criteria. Laser turbidimeters indicate that the instrument utilizes a laser or laser-like light source that produces a collimated and monochromatic light source. This laser incident light source also will possess a very high-energy beam density compared to that of a turbidimeter.

The range of turbidity within a sample can be very broad. The lowest turbidity values would be those exhibited by pure, particle-free fluids such as highly filtered water. The lowest turbidity of pure particle-free water ranges between 0.005 and 0.015 NTU, depending on the instrument design. The turbidity is never zero because of stray light (light that is scattered and detected that does not come from the sample) and the molecular scattering of light. The upper range of turbidity is theoretically limited by the optical design of the specific instrument and the standards used to calibrate the instruments. For most cases the limit of nephelometric turbidity is between 1000 and 4000 NTU, and backscatter turbidity values can measure as high as 100,000 NTU. However, for the intentions of this invention, the turbidity of the sample should be below about 0.5 NTU or 500 milli-NTU or mNTU. Note that 1000 mNTU is equivalent to 1.00 NTU.

It is the particles that generate a turbidity in water and these same particles can also serve as a source of pathogenic transport in water, or the actual particles themselves may be pathogenic. Thus, turbidity is and has been used as a primary analytical parameter to estimate the quality of water. This is why turbidity is a monitoring parameter that is regulated for both consumption and environmental purposes.

One of the primary applications of turbidimeters and other particulate detection instrumentation is to monitor filtration systems for loss in integrity or breakthrough. Filtration itself involves the use of physical, chemical, or electrostatic barriers, either singularly or in combination, to purify a fluid (e.g. water). The inlet fluid flowing to a filter is often referred to as the influent or feed water, and the filtered fluid leaving the filter is referred to as the effluent or filtrate. Examples of filters that are used for drinking water production include: membranes, multi-media, dual media, and slow-sand filters. Membrane systems are becoming more popular in the drinking water industry. These systems utilize micro-filtration or ultra-filtration technologies and theoretically provide an absolute barrier for pathogens with a size greater than one micron. Because of the membrane pore size, they are often perceived to be effective barriers for pathogens such as Cryptosporidium and Giardia.

If one or more of the barriers that comprise a filtration system fails, a condition of breakthrough has occurred. Under this condition, particles that are contained in the influent side of the filter have a direct and uninhibited flow path into the effluent stream, resulting in contamination of the effluent stream. Depending on the nature and severity of the breakthrough, the amount of particle contamination in the effluent stream will vary but can result in compromising human health, since the contamination can be pathogenic or serve as a transport mechanism for pathogens. This is the primary concern when filtering drinking water and the reason why particulate detection instrumentation is recommended or required for the monitoring of a filter effluent stream.

The turbidimeter has historically been the instrument of choice for the monitoring of particulate levels within filter effluent fluids such as drinking water effluent. The light-obscuration particle counter has also been used for monitoring filter effluent. Both instruments can be effective in monitoring for large-scale breakthrough events, but neither has been found to be effective in the prediction of such a breakthrough event or in the consistent detection of fine integrity losses. Other instrument technologies may also be available but their cost may be a limitation.

It is often the fine integrity losses and precursor conditions that prove to be most critical in assuring water quality and safety when intended for human consumption. For many pathogens, the concentration required to impact human health is extremely low. Therefore, a fine integrity loss such as that caused by a small hole in a membrane, or the beginning of a filter-breakthrough event can still have negative impacts on human health. It is these subtle changes in the filtration effectiveness that are often not detected using conventional particle detection instrumentation, in which the actual values are the sole criteria for monitoring the performance of a filtration system.

Pathogens generally represent a distinct size range of interest between 1 and 10 microns. Particles in this size range represent the same size range as many waterborne pathogenic organisms such as Cryptosporidium parvuum, and Giardia lamblia, and are often found in source waters that are treated to become drinking water. Thus, particles of similar size that would be present in an effluent stream are of concern because they can serve as a surrogate for the presence of pathogens. Historically, particle counters have been used to monitor effluent streams for particles in this size range, but the use and application of particle counters for the monitoring of drinking water effluent has many practical limitations. In addition, when fine integrity losses occur, dilution effects limit the detection abilities of such instruments.

Any particle within a sample that is capable of scattering light from a defined incident light source contributes to the overall turbidity in the sample. Thus, the goal of water filtration (or fluid filtration in general) is to eliminate these particles from solution. When filtration systems are performing properly, the turbidity of the effluent is characterized by a low turbidity value. Current turbidity instrumentation which typically utilizes incandescent or long wavelength light sources are effective for the detection of particles to a certain level of particle removal from filtered water, but they become less effective on super-clean waters, where residual particle size and count levels are very low. At these low levels of turbidity the actual sensitivity to a turbidity change can be so small that such a change in the sample turbidity becomes indistinguishable from the instrument's baseline noise. This baseline noise has several sources including: the inherent instrument noise (electronic noise), instrument stray light, sample noise, and noise in the light itself. These interferences are additive and they become the primary source of false positive turbidity response. At these levels of turbidity, the instruments become less reliable and have limited use from a measurement standpoint.

The most common turbidimeters have limitations in sensitivity which limit their application for the monitoring of fine integrity events, such as those just explained. Such instruments typically use an incandescent light for the light source that emits a multi-wavelength spectrum of divergent light. Due to the source being both divergent and polychromatic, the ability to collimate and focus the incident light source is difficult to achieve. The result is a light source that is not as effectively scattered by particles that would otherwise be the case. Second, the scattered light detection system typically uses a lower sensitivity silicon photodiode detector (primarily due to economics). The detector response spectrum and the spectral output of the incident light source partially overlap, which allows the detector to be sensitive to specific wavelengths emitted by the incident light. However, the lack of complete overlap between the detector's response spectrum and the emitted spectrum from the incident light source further limits the sensitivity of the instrument's ability to detect light scatter caused from particles in a sample. That is, the typical combination of this type of light source and detection system used in most turbidimeters yield a lower signal-to-noise ratio which limits the instrument's sensitivity to see very small changes in light scatter. This translates to reduced sensitivity to see fine changes in a turbidity measurement.

Laser turbidimeters (also known as laser nephelometers) possess enhanced optical designs that yield greater sensitivity and baseline stability than traditional instrumentation. The primary distinction between a laser nephelometer and other traditional instrumentation is found in the incident light source and the detector. The laser turbidimeter utilizes a highly collimated, focused light source that is primarily monochromatic. The characteristics of this light source provide for the concentration of its light energy over a very small and defined area located inside the sample chamber of the instrument. This combination provides for an incident beam with a high power density, which can be effectively scattered by particles. The detector is also of greater sensitivity and provides greater response to the specific wavelength(s) emitted by the incident laser light source of the instrument. Further, the detector response spectrum completely overlaps the spectrum emitted by the incident light source. This combination of detector sensitivity, collimated light source, and the high power density of the laser provides for a very high signal-to-noise ratio for the laser turbidimeter. This signal-to-noise ratio enhances the sensitivity to detect very small changes in turbidity and to yield a very stable measurement baseline. With stable baselines, very fine changes in turbidity in a sample are distinguishable.

Currently, turbidity and particle counting methods are only applied using the analytical measurement value (the turbidity value or particle count value) and the direction of movement of these values. For example, the turbidity value is usually monitored for an increase over some interval of time. If the measured analysis value exceeds some imposed level, it is indicative that the process used to produce the effluent stream may need to be investigated. Typically, the baseline variability is ignored and the variability is treated as inherent measurement noise.

Current membrane integrity monitoring methods have been limited. The pressure decay test is the most common for integrity monitoring. Although this test is effective, it requires that an entire membrane rack be taken off-line to perform the test. The effectiveness of the test, of course, is limited to the frequency at which the pressure decay test is performed. If a membrane failure occurs between scheduled tests, contamination with unfiltered water would continue undetected until the next scheduled test is completed, and the probability of pathogen passage into the effluent stream substantially increases. The drinking water regulatory authorities often interpret membrane filtration as a single barrier against pathogen passage. If pathogens happen to pass through a membrane, there is no other means to detect or remove them prior to entering the water distribution system.

A relatively new method for monitoring membrane integrity is the spiked integrity method (SIM). This method involves spiking a defined quantity of activated carbon that has been characterized with respect to particle size and distribution into the influent line leading to the membrane rack. A log removal value is calculated based on how much of the carbon material is detected in the effluent of the membrane vs. the amount of material that was spiked into the influent. However, the materil will be costly because the particle size and distribution must be characterized. There are also labor and capital costs associated with spiking the material, running the instrumentation, and determining the log removal value. Also, the method is unable to trace an integrity loss to a specific module or element and does not provide a continuous analysis method for integrity.

There has not heretofore been provided a system for accurately and efficiently monitoring the effluent stream of a fluid (such as treated water) to detect fine integrity losses such as those that can occur in filtration (e.g. membrane filtration) and to predict large-scale breakthrough events that can occur in other filtration processes such as those used in drinking water plants.

### SUMMARY OF THE INVENTION

It is an object of this invention to provide a system for accurately and continuously monitoring the fluid effluent of a plant to detect fine integrity losses.

It is another object of this invention to provide a system for accurately and efficiently monitoring the fluid effluent of a plant to predict large-scale breakthrough events.

It is a further object of this invention to provide a system for measuring the baseline variability of a distinct measurement parameter (such as turbidity) of a fluid.

It is yet another object of this invention to provide a system for monitoring the baseline variability of a distinct measurement parameter and then analyzing that baseline variability as a separate parameter. The system is also able to monitor each membrane element (module) in an entire membrane rack.

It is a further object of this invention to provide for a qualitative aspect of laser turbidimetric analysis which is sensitive to various selected sizes of particles.

To accomplish the foregoing and other objects, in one embodiment, the present invention provides a monitoring system comprising (a) a sample cell sensor having an inlet and an outlet for a fluid sample to be tested, (b) a light source, (c) detector means, (d) a pair of fiber optic cables (one cable for transmitting light from the light source to the sample cell sensor and one cable for transmitting scattered light from the sensor to the detector), and (e) means for measuring baseline variability of a fluid parameter (such as turbidity in a liquid). In another embodiment of the invention, instead of measuring the turbidity of the liquid sample, a particle counter is used. In such event, light is transmitted through the liquid sample in the cell. Where the light encounters particles in the liquid, the light is prevented from traveling through the liquid to the detector. The type of signal transmitted to the detector in this situation is referred to as a light extinction signal. When using a particle counter, it is not necessary to use a fiber optic cable for the light source.

Thus, in one embodiment, the system utilizes a laser turbidimeter to measure turbidity of a fluid sample such as water. In another embodiment, the system utilizes a particle counter to determine the number of particles within a given size range in a liquid.

In one embodiment, a single light source is adapted to sequentially direct a light beam into each of a plurality of sample cell sensors, and a single detector means is adapted to detect light which is scattered by the liquid sample in each of the sample cell sensors. A separate pair of fiber optic cables is operatively associated with each sample cell sensor, and the light source and detector are moved sequentially from one pair of fiber optic cables to another, as desired, to obtain data from each sample cell sensor.

The system of this invention enables efficient monitoring of the turbidity or other desired parameter of a plurality of liquid samples contained in a plurality of separate cell sensors, without requiring a separate light source and separate detector for each sample cell. Rather, in a preferred embodiment the system utilizes a common light source, detector means, associated control electronics, display, etc. Other types of parameters can be measured and monitored using the concepts of the present invention where light is used to determine the presence or absence of particles in the sample. The view volume in the cell should be sufficiently small that low numbers of particles can effectively scatter sufficient light to reach the detector in a quantifiable amount.

Other advantages and features of the monitoring system of the invention will be apparent from the following detailed description and the accompanying drawings.

### BRIEF DESCRIPTION OF THE DRAWINGS

The present invention is described in more detail hereinafter with reference to the accompanying drawings wherein like reference characters refer to the same parts throughout the several views and in which:

FIG. 1 shows an integrity monitoring system of this invention as used with a plurality of membrane modules or filters for filtering drinking water;

FIG. 2 is a graph showing changes in turbidity response resulting from the repair of damaged membrane fibers in a filter module;

FIG. 3 is a graph showing percent RSD (relative standard deviation) and mNTU responses for severed fibers in a membrane filter module;

FIG. 4 is a graph showing sensitivity of a % RSD parameter to a low number of spiked particles in a liquid sample;

FIG. 5 illustrates a system for positioning the light source and detector in operative relation to a selected pair of fiber optic cables in the system show in FIG. 1;

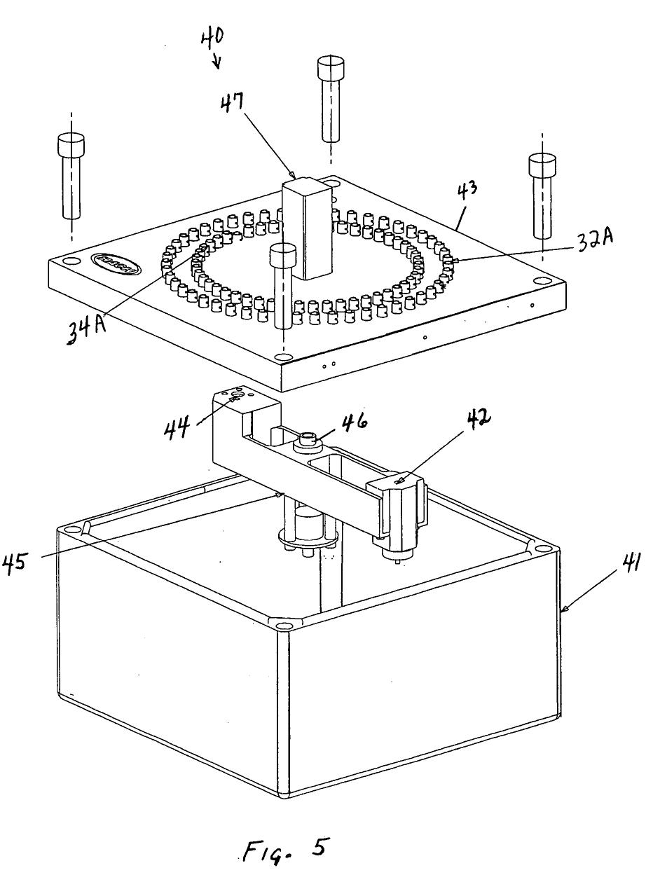

FIG. 6 is a cross-sectional view of a preferred embodiment of a sample cell used in this invention;

FIG. 7 is a graph showing how turbidity and particle count signals become more unstable as the filter run ages;

FIG. 8 is a schematic drawing of a laser turbidimeter;

FIG. 9 is a schematic drawing of a particle counter.

### DETAILED DESCRIPTION OF THE INVENTION

For the purposes of this invention, the use of the word “turbidity” indicates the use of turbidity instrumentation, or instruments that are of similar characteristics and capable of making similar measurements. This can also include but is not limited to turbidimeters, nephelometers, light obscuration particle counters, and similar instrumentation. Appropriate light sources include a laser, laser diode, or light-emitting diode (LED). Thus, reference hereafter to the turbidity measurement value refers to the typical measurement from one of these types of technologies and respective instruments.

The measurement of variability itself is quantified through a single statistical process known as the relative standard deviation or RSD. The RSD is calculated as the standard deviation for a given set of measurements divided by the average for the same set of measurements. The quotient is then multiplied by 100 to express this result as a percent. The RSD parameter uses a separate and unique set of measurement values for each successive calculation. Overlapped data is not used for turbidity because it is frequently generated. However, in the case of a particle counter, where the particle count distribution is calculated for a specific measurement cycle, it takes between 15 seconds to several minutes to complete. For longer measurement cycles, overlapping data can be used on a running basis. For example, the average and RSD can be calculated on the last seven measurements performed, with each new set using at least one new data point.

The set of data that is collected and used for the calculation of the RSD is applied using an inclusive set of measurement values. This set of data must also be collected over a relatively short time interval, preferably in the seconds or faster range. A more rapid frequency of the collection of measurements will provide for a better opportunity to accurately predict a breakthrough event or to detect a fine integrity loss regarding a filtration process. The longer the time taken to collect the turbidity data, the lower the detection ability of the process.

Once the RSD value is calculated, it is treated as a separate parameter and traditional statistical analysis techniques can be applied to this parameter. In doing so, the variability of the RSD parameter can be assessed independently for relative change. When this RSD parameter suddenly changes from a stabilized baseline, it is the indication that particles are present in the filtrate stream coming from a specific filter.

Depending on the wavelength of incident light, the detection angle of the scattered light detector, the size of the measurement or view area, the size threshold of the resultant particles from an integrity loss event can be estimated. This size threshold indicates that the particles in the stream are greater than a defined size or smaller than a defined size. This defined size threshold will be unique to the optical design characteristics of the instrument and is confirmed through testing with defined particle size standards.

The present invention involves the analysis of turbidity measurement or particle counter data that results from the monitoring of the effluent stream exiting a filtration process (e.g. conventional, multi-media, sand, and various types of membrane filtration). When a filter is intact, it is characterized by having no breaches, tears, holes, severed fibers, media breakdown, breakthrough, or any other form of integrity loss. The only particles that will be passing into the filtrate stream are those that are smaller than the defined physical boundaries exhibited by the filter or respective filtration process. The larger particles that are intended to be filtered from the feedwater stream will be absent from the effluent stream leaving the intact filter. The resultant incidence of particles is very low and the resultant turbidity values will also be very low. The baseline variability of the respective turbidity values will also be very low and constant over a defined interval of time.

When a loss of integrity does occur, larger particles (relative to those that normally would pass through a filter) are able to pass directly into the effluent stream. Depending upon the severity of the integrity loss, these particles may or may not impact the turbidity measurement. A very fine integrity loss may not show any recognizable change in the turbidity, but the variability regarding this turbidity measurement will likely change. With a larger integrity loss, the turbidity value will likely change and would also be complemented by an increase in the baseline variability. The presence of only a very limited number of larger particles in the effluent stream is sufficient to cause the baseline variability to increase. The laser turbidity value may trend upward in the event of an integrity loss if the concentration of contaminant particles is sufficient. However, if the integrity loss is very fine or if a precursor condition to a major breakthrough event is prevalent, the upward trend of a turbidity or particle count measurment value may not occur, and the described events would proceed through time undetected. In the system of this invention, the variability within the measurement baseline does change in response to the event, which is caused by a very limited concentration of large particles.

When treated as a separate parameter, the baseline variability indicates the presence of particles at very low concentrations. If this parameter is combined with the turbidity measurement parameter, information regarding the nature of the integrity loss can be deduced from one of the following four situations:

1. If the baseline variability parameter increases and the turbidity increases, the integrity loss is significant enough that large concentrations of small particles and either a small or large concentration of large particles are present in the effluent stream. Typically, the integrity loss is significant.

2. If the baseline variability parameter increases but the turbidity does not change, the integrity loss is allowing very few particles into the effluent stream, but these particles are large in size and serve as a surrogate for specific waterborne pathogens. This is often the condition that also serves as a precursor to a major filtration breakthrough event, and thereby serves as a prediction method of such an event.

3. If the turbidity parameter increases and the baseline variability parameter does not change, the integrity loss is such that no large particles are passing into the effluent stream. In this case, other filtration processes have eliminated the larger particles, or a change in the feedwater has occurred. Such an integrity loss may not be of concern since the surrogate particles for waterborne pathogens are absent in the filtrate stream.

4. Both the baseline variability parameter and the turbidity parameter are unchanged. This is an indication that the filter or filtration process is intact.

The cause in the increase in the baseline variability is triggered by the influx of only a very small number of large (1 micron or larger) particles that will pass into the measurement view area of the instrument. This size threshold can be varied, depending on the exact wavelength of light used for the incident light source, the detection angle for the respective light scattered detectors, and the analysis volume that is created between the incident beam and the scattered detector view volume. With respect to the analysis volume, the smaller this volume, the higher the sensitivity of the baseline variability parameter with respect to size and concentration of particles in the analysis volume. Also, the energy within the analysis volume must be sufficient to be effectively scattered by a particle once it passes into and through the view volume. Lasers, laser diodes, and LED light sources in the visible wavelength range are suitable for meeting this energy requirement for the incident light source.

In the event of an integrity loss, the initial influx of particles may or may not cause the baseline turbidity level to immediately change, but the variation in the baseline stability will immediately change. The system and method of the present invention provide a much more sensitive technique for the detection of a filtration problem than those traditional methods in which only the turbidity or particle count value are used to assess performance of a filtration process. The method and system of this invention can be used to: 1) detect a fine filtration integrity loss, 2) detect the precursor for a major breakthrough event, 3) qualifying the event with respect to the sizes of particles that are being detected. To be effectively used, the invention utilizes both the baseline variability (RSD parameter) with or without the turbidity parameter. The baseline variability parameter is always used.

The RSD measurement value is generated each time the instrument performs a measurement. The newest value is compared to the previous values and a percent difference between the new and the previous defined number of values can be determined. If the percent difference of the new instrument value for RSD increases beyond a defined limit, the indication of a particle event due to a filtration integrity loss has occurred.

The instrument used in the system and method of the present invention must have a defined coherent light source that is composed of a single wavelength of light, such as those exhibited by lasers. The detector must have response spectra that overlap the spectral output of the incident light source. These features enable an extremely low noise baseline to be developed. The analysis volume for the sample should be extremely small so that a single or a limited concentration of particles in the 1-2 micron range are capable of effectively scattering the incident light in the direction of the scattered light detector, resulting in an instrument response, and will immediately result in a change in the RSD parameter. Further, the RSD parameter should be based on measurements that are taken within a very short time interval. This allows for each measurement to be event-specific and prevents the blending of data over time, through averaging processes. Finally, the instrument is most effective if it possesses degassing devices to eliminate gas bubbles (e.g. air) Air bubbles act as particles and will scatter light creating false positive turbidity and baseline variability or RSD spikes.

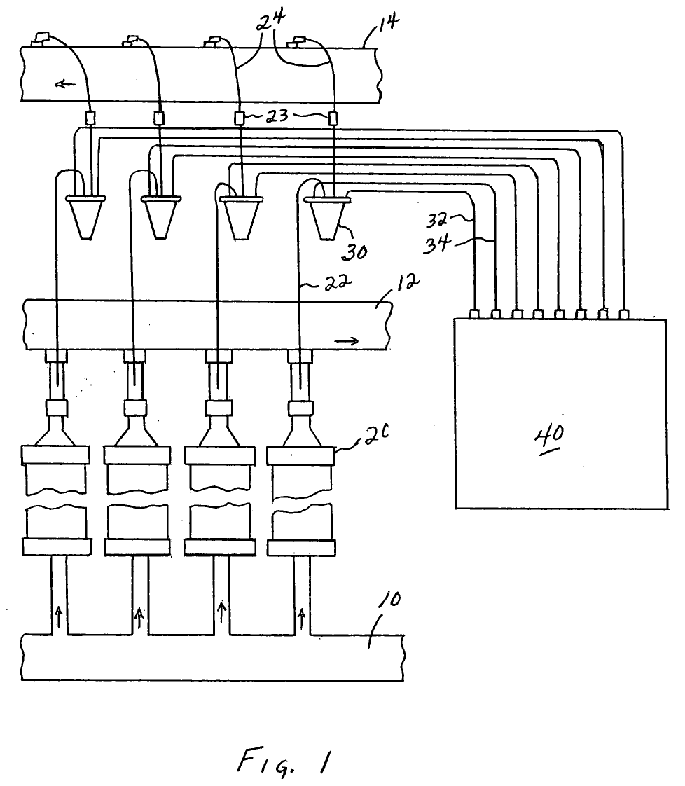

In FIG. 1 there is shown one embodiment of a monitoring system of the invention. There are shown a plurality of membrane modules for filtering water. Each module comprises a plurality of membrane fibers through which the influent water flows. For each membrane module there is an associated sample cell sensor. The sampling point for each sensor is in the filtrate line approximately 12 inches above the surface of the ends of the membrane filters. The volume of each sample cell sensor is preferably about 25 mL. However, larger sample volumes can be used, if desired, but larger volumes dampens the significance of the influx of particles through dilution, which delays the response.

The light source and detector module is remotely located from the cell sensors, as shown. The light source is preferably a laser, laser diode, or other source (e.g. LED) which is capable of providing a single wavelength incident light beam.

A preferred monitoring system of the invention is illustrated in FIG. 1 in connection with a membrane module filtration system for drinking water. Influent water from pipe 10 enters each of a plurality of membrane filter modules 20 where the water is filtered. Each membrane filter includes hundreds or even thousands (e.g. 6500) of hollow fibers having porous walls with very small pore size. Effluent (i.e. filtered water) from each module exits into pipe 12. Effluent can also be referred to as filtrate or permeate.

For monitoring purposes, a separate sample cell 30 is associated with each membrane module 20. Inlet tube 22 draws filtered water from the top of a module 20 and carries it to a respective sample cell 30. The water passes through the sample cell and travels through tube 24 to recycle stream 14. A flow restrictor 23 is preferably used in tube 24 to increase the back pressure in the sample cell to prevent out-gassing and subsequent bubble formation. Each sample cell has a volume preferably less than about 25 mL, thereby providing enhanced response and sensitivity to short-term particle events. The interior walls of the cell absorb incident light reflections (known as stray light) of the specific wavelength used in the instrument. By eliminating stray light and reducing the baseline noise, the sample cell increases sensitivity of the instrument.

Two fiber optic cables 32 and 34 are associated with each sample cell. One of the cables is for transmitting the incident light beam from the light source at the base station 40 (optical and mechanical multiplexor) to the sample cell. The other cable is for transmitting a light signal from the sample cell sensor back to the detector means. For example, when the instrument is measuring turbidity of the liquid stream, the incident light from the light source is scattered by particles in the liquid, and a portion of the scattered light is transmitted via the fiber optic cable coupling to the detector means at base station 40. The detector response is measured at a rapid interval (e.g. this can vary between once per 0.1 second to about once per 3 seconds) until a minimum of 20 measurements is collected, after which the RSD algorithm is applied. The RSD algorithm takes the top 50% of the measurements and eliminates them, leaving 10 measurements. It then eliminates the lowest three measurements, leaving seven. From these seven measurements, the average or mean and the standard deviation are calculated. The average value is plotted as one parameter. The final calculation then generates the RSD value, which is the standard deviation divided by the average. The quotient is then multiplied by 100 to express the value as a percentage. A change in the turbidity level or a change in the percent relative standard deviation confirms that the membrane filter integrity is, or is not, intact.

There are variables in the number of measurements taken overall, the number of high measurement values that are eliminated, and the number of low-level values that are eliminated. The variation of this algorithm is dependent on the sample and how effectively any interferences (namely, bubbles) are eliminated. If bubbles are significant, then a higher percentage of high values may need to be eliminated. Or, a larger sampling is taken, which is then followed by taking a higher or lower number of values and eliminating them. The number of measurements taken may vary from about 4 to 50 or more. The number of high-end values eliminated may vary from 0 to 80%, and the number of low-end values eliminated may vary from 0 to 30%, for example. Once the RSD and turbidity values are calculated, they are treated as separate measurement parameters. Each time a value is calculated it is typically plotted over time by the instrument software. Over time, the values for each parameter are plotted in a continuous rate to generate the respective baselines. A sudden change in either baseline (over one or two consecutive measurements) indicates a breach in the filtration process. Depending on which parameter changes and the degree of change, qualitative information regarding the integrity loss can be deduced.

The base station 40 comprises enclosure 41 and lid 43. Within the enclosure there are included the light source 42 (typically a laser or laser diode), detector means 44, rotatable positioning arm 45 on which the light source and detector means are carried, stepper motor 47 for driving the rotatable arm (which rotates on shaft 46) and positioning it in very specific radial positions, and the electronics for determining and displaying the turbidity measurements (or other selected sample parameter of interest). The outer circle of couplers 32A is for the plurality of fiber optic cables 32 which transmit a light beam from the light source to a particular sample cell when the light source is positioned directly over a particular coupler. The inner circle of couplers 34A is for the plurality of fiber optic cables 34 which transmit a signal from a particular sample cell to the detector means. By rotating arm 45, the light source and detector means are aligned with a particular set of couplers 32A and 34A for a particular sample cell. When a sample cell is monitored, several measurements are statistically processed to remove outlying values, and then the average turbidity (relative to a turbidity calibration) and the respective relative standard deviation are generated from these remaining measurements. The measurements are then compared to the previous mNTU and % RSD baselines. If a change occurs that exceeds the baseline by a significant amount, the measurement is repeated. If a second measurement shows that the baseline value is still exceeded, an alarm is activated for that sample cell, notifying the operator that the membrane module is suspected of an integrity breach.

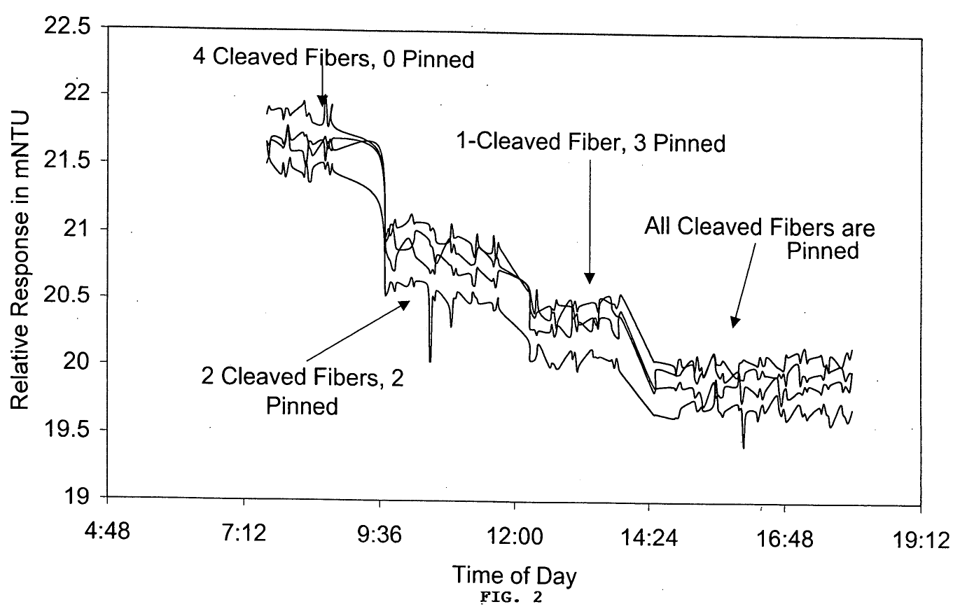

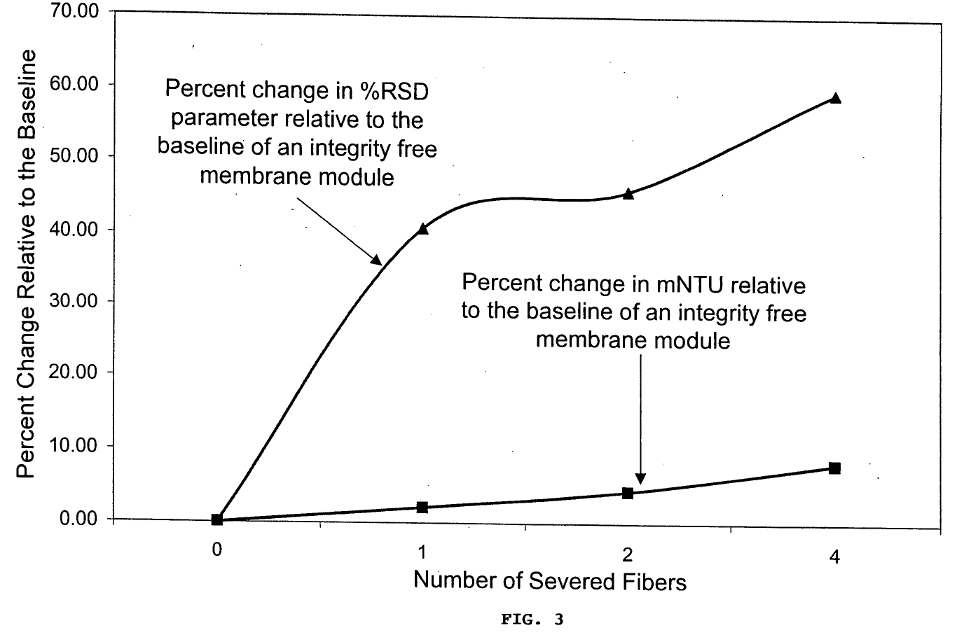

To illustrate the effectiveness of the monitoring system, a test was conducted with a full-scale membrane module. Four fibers (out of a total of 6500 fibers) were severed, and the turbidity of the water was monitored (with four separate sample cells) before and after each severed fiber was pinned or plugged. The graph of FIG. 2 illustrates how the water filtrate quality increases (i.e. reduction in mNTU) after each successive pinning of the severed fibers. The graph of FIG. 3 illustrates the percent change relative to the baseline for the average mNTU and the baseline for the average %RSD. The data in FIG. 3 demonstrates that the integrity sensitivity was enhanced over the turbidity sensitivity by more than 10-fold when the %RSD process calculations were utilized. This graph also shows that a correlation can be drawn between the %RSD and the degree of integrity loss that occurred during the test.

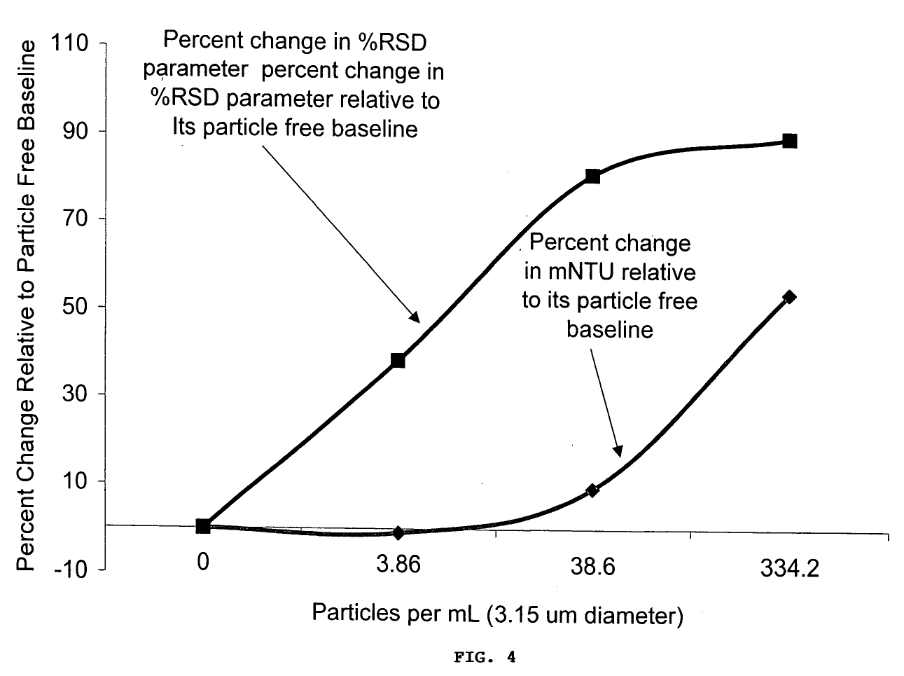

Another test was conducted with a membrane filter that removes particles in the 2-5 micron range. This is the size range of pathogens such as Cryptosporidium and Giardia. FIG. 4 is a graph illustrating how a few particles (3.15 microns) added to particle-free water can add a significant amount of noise to the turbidity baseline and therefore can substantially increase the %RSD relative to the %RSD of an intact membrane filter module. This graph also displays the comparison in baseline changes between the %RSD and the turbidity baseline. With the addition of about four particles to the water, the %RSD showed a substantial increase while the turbidity baseline did not change. This is based on the addition of particles of 3.15 microns in size, which are a common surrogate size for pathogens such as Cryptosporidium parvuum.

The system of this invention can detect small numbers of particles in liquids in the range of 0.028 to greater than 10 microns and is extremely sensitive to particles in the 1-5 micron range. The detection of turbidity changes is very sensitive and the system has demonstrated the ability to detect a single broken fiber for every 10,000 fibers present in a membrane filter module (based on a feedwater turbidity in the range of 0.8 to 2.0 NTU). The system analyzes the baseline variability (e.g. of turbidity or other selected parameter) and calculates the present Relative Standard Deviation (%RSD). This parameter allows for detection of small integrity losses.

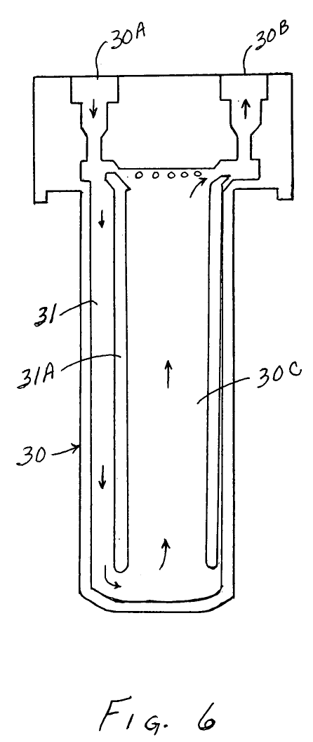

A preferred sample cell 30 is illustrated in FIG. 6. This sample cell can accommodate a continuous sample flow of 50-150 mL per minute. The volume of the cell is less than about 25 mL, providing rapid and enhanced response to short-term particle events. The sample enters the cell through inlet port 30A at the top and then immediately enters a bubble removal chamber 31 having a small opening at the top and a larger opening at the bottom. The rejection of bubbles is based on the buoyancy of air in the sample. Any air will float to the top of this chamber and will pass through the small opening near the top of the chamber. The liquid sample itself flows downward through the chamber and passes beneath the lower end of the chamber wall 31A, as illustrated, and into the measurement chamber 30C where the light beam from the light source penetrates the sample. The light receiver for scattered light is also located in this chamber. Any debris in the sample will scatter a portion of the incident light in the direction of the receiver which captures the light and transmits it via fiber optic cable back to the detector means. The sample chamber is lined with a light absorbing material that prevents internal reflections. After the sample has continued upward in the chamber, and past the view volume (i.e. light beam and light receiver area), the sample exits the cell through outlet port 30B.

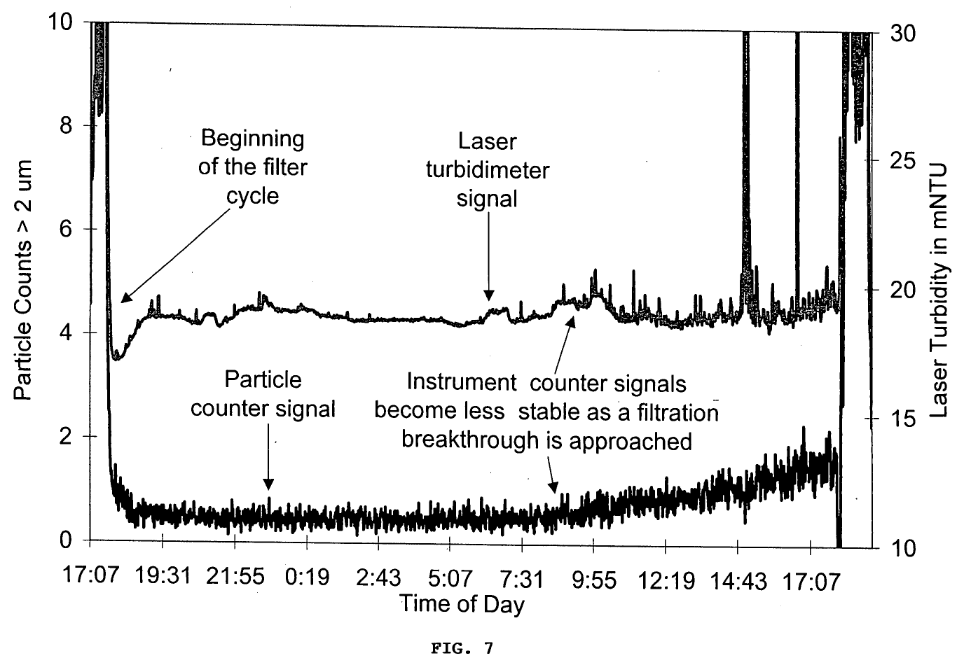

FIG. 7 is a graph showing that turbidity and particle count signals become more unstable as the filter run ages. The RSD parameter quantifies this variability in the baseline and serves as a precursor to impending filter breakthrough. The value of the turbidity signal does not trend upward over time, but the variability does continue to increase.

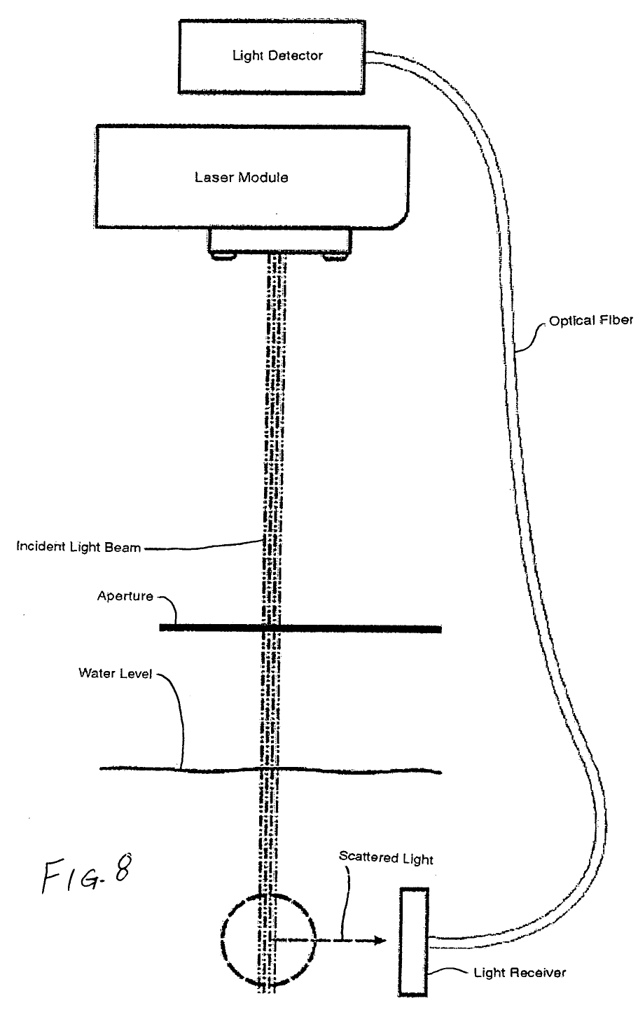

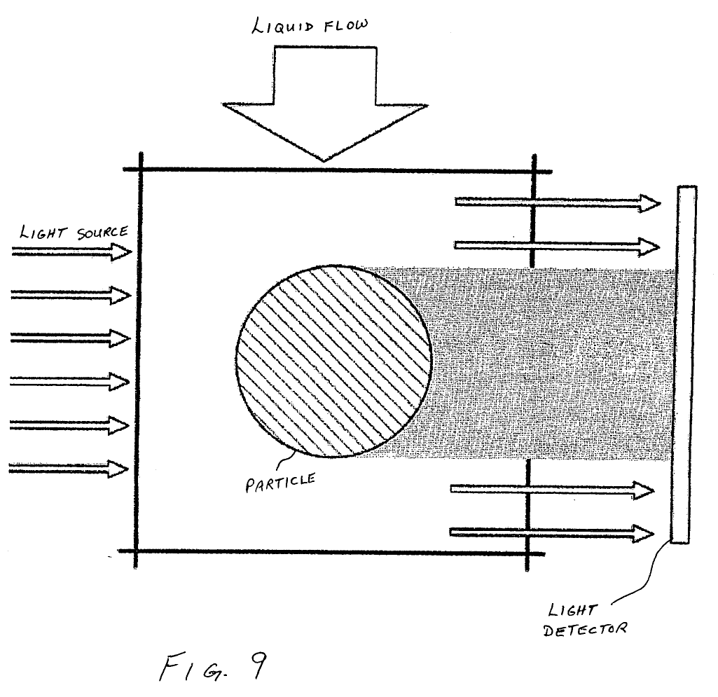

FIG. 8 is a schematic drawing of a laser turbidimeter. FIG. 9 is a schematic drawing of a particle counter showing how the presence of a particle in a fluid flow will obscure a portion of the incident light beam.

Other variants are possible without departing from the scope and spirit of this invention.

What is claimed is:

1. A monitoring system for monitoring a parameter of a fluid stream, said system comprising:
(a) a sample cell having inlet means communicating with said fluid stream and having outlet means for enabling fluid to exit said sample cell;
(b) light source means for providing a collimated light beam;
(c) detector means;
(d) a first fiber optic cable for transmitting said light beam to said sample cell where said light beam is directed into said fluid stream and a signal is created corresponding to said parameter;
(e) a second fiber optic cable for transmitting said signal to said detector means; and
(f) means for measuring baseline variability of said parameter.

2. A monitoring system in accordance with claim 1, wherein said system comprises a plurality of said sample cells each associated with a separate fluid stream; and further comprising a pair of said first and second fiber optic cables in operative relation with each of said sample cells.

3. A monitoring system in accordance with claim 2, wherein said system comprises a single light source means and a single said detector means; and wherein said system further comprises means for selectively positioning said light source means and said detector means in operative relation with a selected pair of said fiber optic cables.

4. A monitoring system in accordance with claim 1, wherein said light source means comprises a laser.

5. A monitoring system in accordance with claim 1, wherein said parameter comprises turbidity of a liquid.

6. A monitoring system in accordance with claim 1, wherein said parameter comprises particle counting of a liquid.

7. A monitoring system for monitoring a parameter of a plurality of liquid streams, said system comprising:
(a) a plurality of sample cells each having inlet means communicating with one of said liquid streams for enabling liquid to enter said cell and having outlet means for enabling liquid to exit said sample cell;
(b) light source means comprising a laser for providing a collimated light beam;
(c) detector means;
(d) a pair of fiber optic cables in operative relation with each said sample cell; wherein each said pair comprises: (i) a first fiber optic cable for transmitting said light beam to one of said sample cells where said light beam is directed into said liquid in said sample cell and a signal is created corresponding to said parameter, and (ii) a second fiber optic cable for transmitting said signal to said detector means;
(e) means for measuring baseline variability of said parameter; and
(f) means for selectively positioning said light source means and said detector means in operative relation with a selected pair of said fiber optic cables.

8. A monitoring system in accordance with claim 7, further comprising a plurality of filter modules for filtering water; wherein the output of each of said filter modules is a stream of drinking water; and wherein said inlet means of one of said sample cells communicates with the output of one of said filter modules.

9. A monitoring system in accordance with claim 8, wherein said system comprises a single said light source means and a single said detector means; and wherein said system further comprises means for selectively positioning said light source means and said detector means in operative relation with a selected pair of said fiber optic cables.

10. A monitoring system in accordance with claim 8, wherein said light source means comprises a laser.

11. A monitoring system in accordance with claim 8, wherein said parameter comprises turbidity of a liquid.

12. A monitoring system in accordance with claim 8, wherein said parameter comprises particle counting.

13. A monitoring system for monitoring a parameter of a fluid stream, said system comprising:
(a) a sample cell having inlet means communicating with said fluid stream and having outlet means for enabling fluid to exit said sample cell;
(b) light source means for providing a collimated light beam which is directed into said fluid stream and a signal is created corresponding to said parameter;
(c) detector means;
(d) means for transmitting said signal to said detector means; and
(e) means for measuring baseline variability of said parameter.

14. A monitoring system in accordance with claim 13, wherein said light source means and said detector means comprise a particle counter for counting particles in said fluid stream.
